(19) United States
(12) Patent Application Publication
(10) Pub. No.: US 2026/0278171 A1
(43) Pub. Date: Sep. 17, 2026

(54) System and Method for AI Contribution Analysis, Transparency, and Accreditation

(71) Applicant: KENNETH M CONTI, REHOBOTH, MA (US)

(72) Inventor: KENNETH M CONTI, REHOBOTH, MA (US)

(21) Appl. No.: 19/076,329

(22) Filed: Mar. 11, 2025

(51) Int. Cl. G06F 21/64; G06Q 30/018

(52) U.S. Cl. CPC G06F 21/64; G06Q 30/018

(57) ABSTRACT

A system and method for analyzing and verifying the respective contributions of artificial intelligence (AI) and human users within digital content creation, decision-making workflows, and collaborative environments. The invention comprises a contribution analysis engine that attributes authorship by evaluating idea origination, structural modification, contextual influence, and decision impact. A real-time interaction logging module captures inputs and outputs, while a composite influence score quantifies the degree of AI involvement versus human contribution. The system includes a secure certification mechanism that generates traceable validation links for independently verifying content origin and authorship. Designed for deployment across academic, corporate, legal, and government sectors, the framework supports ethical Al integration, authorship transparency, and regulatory compliance. It enables digital trust by validating intellectual input at scale without persistent data retention. This system may further include cryptographic safeguards, audit trails, and privacy-compliant verification protocols to ensure authenticity and protect the integrity of AI-assisted outputs across diverse information ecosystems.

### FIELD OF THE INVENTION

This invention relates to artificial intelligence (AI) compliance, authorship tracking, and accreditation. Specifically, it provides a system and method for tracking, verifying, and quantifying the contributions made by AI versus a human within digital conversations, collaborative workflows, automated decision-making processes, and content creation.

### BACKGROUND OF THE INVENTION

With the rise of AI-powered assistants such as ChatGPT, Bard, and other generative AI systems, businesses, governments, and individuals face challenges in:
Proving Human vs. AI Authorship.
Ensuring Transparency in AI-Assisted Decision-Making.
Legal and Ethical Accountability in AI-generated works.
AI Accreditation for Compliance & Verification.

Currently, no system exists that transparently tracks AI vs. human contributions in real-time while applying psychological and human behavior principles to optimize accountability and fairness.

### SUMMARY OF THE INVENTION

This invention introduces a cloud-based AI contribution tracking system that provides:
Real-Time AI-Human Collaboration Tracking.
AI Accreditation & Compliance System.
AI Transparency & Verification Reports.
A User Dashboard & API for Enterprise and Regulatory Adoption.
An AI Influence Score (AIS) to measure the impact of AI-generated content.
A Truth Verification Layer to ensure all AI-generated content remains tamper-proof and fully transparent.
A Real-Time Audit & Appeal Process to ensure AI tracking accuracy remains up to date with human behavior trends.
A Monetization & Commercialization Framework to ensure this system is widely adopted and profitable.
A Security & Data Protection Compliance Layer to ensure privacy, encryption, and AI-generated data integrity.
A Verification & Sharing Mechanism that allows AI-generated contributions to be shared via a secure, traceable URL for independent validation.
A Personal AI Trust Score (PATS) that evaluates individual AI reliance, contribution levels, and ethical AI use, similar to a credit score.
A Real-Time AI Engagement Tracking System that measures user-AI interaction patterns, usage frequency, and AI-driven decision-making influence.

Additionally, this system includes two critical components:
AI Transparency Accreditation (AITA): The global standard that sets rules for AI transparency & compliance.
AI Transparency Certificate (AITC): The verification system that validates AI-human contributions in any given work.

### AITA (Accreditation) vs. AITC (Certification)

### Purpose:

AITA (Accreditation): Maintains global AI transparency standards.
AITC (Certification): Certifies AI-human contributions in specific work.

### Who Uses It?:

AITA (Accreditation): Governments, businesses, universities.
AITC (Certification): Individuals, researchers, professionals.

### How It Works:

AITA (Accreditation): AI systems must comply with AITA to be trusted.
AITC (Certification): AI-generated work must have an AITC to be valid.

### Example:

AITA (Accreditation): Universities requiring AI writing tools to be AITA-compliant.
AITC (Certification): A student submitting an essay with an AITC showing AI was only used as a research tool.

### Legal Impact:

AITA (Accreditation): Ensures AI companies operate within ethical & legal standards.
AITC (Certification): Protects individuals from AI plagiarism & misattribution.

### Why This Changes Everything:

AI Will No Longer Be a Black Box—Every AI-generated output will require proof of transparency.
Companies Can't Hide AI Contributions—If a company falsely claims “100% human-created content” but used AI, the AITC will expose it.
Misinformation is Drastically Reduced—News, research, and government reports must prove AI involvement before being published.
AI is Repositioned as a Tool, Not a Replacement—The AITC system enforces AI as an assistant, not a content generator that replaces humans.
Individuals Benefit from Ethical AI Use—People using AI honestly (as a research or writing assistant) get proper credit, not penalized.
Continuous AI Auditing & Appeals System—AI must remain aligned with human decision-making and adjust based on real-world human behavior studies.
AI Accreditation & Verification Monetization—Companies and institutions must pay for AI compliance services, ensuring sustainability.
AI Security & Privacy Protection Measures—Ensures AI-generated data is encrypted, auditable, and complies with industry security standards.
AI Transparency Sharing & Validation—AI-generated content is linked via a secure URL to allow independent verification of authenticity.
AI Trust Score for Individuals & Organizations—Measures AI reliance, ethical use, and trustworthiness, acting as a “credit score” for AI-generated work.
AI Engagement Tracking System—Captures how often users interact with AI, the extent to which AI suggestions are followed, and trends in human-AI collaboration.

### DETAILED DESCRIPTION OF THE INVENTION

### System Overview

The system consists of a multi-layered AI contribution tracking framework:
User Interaction Layer—A user engages with an AI assistant.
Data Logging Module—The system records all interactions, tagging responses as Human Input or AI Output.
AI Contribution Analysis Engine—Tracks AI vs. human contribution, ensuring transparency of intellectual input, idea origination, content modification, decision-making influence, and AI engagement levels.
Tracks whether the user adopts AI-suggested ideas.
Distinguishes between Human Thought and Intellectual Contribution vs. AI Assistance.
Assigns an AI Influence Score (AIS) based on multiple weighted factors, forming a composite score:
Creativity Influence (Was the idea originally proposed by AI or the user?)
Structural Modification (How much of the original AI-generated content was changed?)
Contextual Dependence (Was AI merely refining an idea or actively shaping the final product?)
User Dependency Level (Did the user iterate and improve AI suggestions, or accept them outright?)
Decision-Making Impact (Did AI shape a critical business, financial, medical, or legal decision?)
AI Engagement Score (How often is AI used, and to what extent does it influence daily operations?)
Identifies idea origination, transformation, and final authorship attribution.

### Conclusion

This invention establishes the first global AI accreditation standard, ensuring AI-generated content is transparent, traceable, and accountable. A.I.T. becomes the AI trust layer for individuals, businesses, and governments, preventing misinformation, ensuring ethical AI use, and verifying authorship in critical applications while introducing AI engagement tracking to analyze the influence and frequency of AI interaction in various sectors.

1. A system for AI contribution tracking, comprising:
A data logging module configured to record AI-human interactions in digital conversations, automated decision-making workflows, and content generation.
An AI Contribution Analysis Engine that tracks, evaluates, and quantifies AI vs. human contribution, including intellectual input, idea origination, structural modification, and decision-making influence.
A verification mechanism that assigns an immutable certification URL for AI-generated content validation.
An AI Trust Score (PATS) assigned to individuals and organizations based on AI reliance, ethical AI use, and transparency compliance.
An AI Engagement Tracking System measuring AI-human interaction frequency and decision impact.
A method for AI transparency verification, comprising:
Identifying AI-generated content in digital workflows and decision-making systems through structured logging and metadata tagging.
Assigning an AITC certification verifying human vs. AI contribution levels, including content modification, structural changes, and contextual relevance.
Encrypting and securely storing authorship and influence data for regulatory compliance and AI transparency enforcement.
Providing a real-time audit and appeal process for AI content verification disputes, ensuring fairness and continuous compliance monitoring.
Dependent Claims (Expanding on Core Claims)
The system of claim [0002], further comprising:
A cryptographic and blockchain-based verification system ensuring the secure, immutable certification of AI-generated content.
The system of [0002], wherein:
The AI Contribution Analysis Engine dynamically adjusts AI Influence Scores based on user engagement trends.
The system of [0002], wherein:
The AI Trust Score (PATS) is calculated using multi-tiered weighting, including AI reliance frequency, ethical use validation, and transparency history.
The method of [0003], further comprising:
A compliance monitoring system that flags AI-generated content exceeding predefined AI Influence Score thresholds.
The method of [0003], wherein:
The audit and appeal process includes third-party oversight for regulatory enforcement of AI transparency.
